(19) United States
(12) Patent Application Publication
(10) Pub. No.: US 2006/0059080 A1
(43) Pub. Date: Mar. 16, 2006

(54) Online electronic trading system including lines of credit

(76) Inventors: Heidi Benko, New York, NY (US); Jeff Rohe, Jersey City, NJ (US)

Correspondence Address: KENYON & KENYON LLP, ONE BROADWAY, NEW YORK, NY, 10004, US

(21) Appl. No.: 11/228,168

(22) Filed: Sep. 15, 2005

Related U.S. Application Data
(60) Provisional application No. 60/610,313, filed on Sep. 16, 2004.

(51) Int. Cl. G06Q 40/00

(52) U.S. Cl. 705/37

(57) ABSTRACT

An electronic trade service device includes processing devices providing computational functions providing negotiation and resolution of commercial agreements between buyers and sellers. The service includes defining contract terms, including price and payment terms and securing electronic connections by the buyer and seller to an electronic trade system. The buyer is associated with one or more credit providers which may pledge financial support based on defined terms. When the agreement is finalized at least a portion of the line of credit relating to the price term is pledged to securing payment by the buyer to the seller in exchange for producing the contractual items. The buyer utilizes a line of credit provided by one or more credit providers so that the commercial agreement between the buyer and seller. The trade service also allows the buyer to choose from an array of credit and financing options for conducting business transactions.

### RELATED INVENTIONS

The Present Application relates to and claims priority from Provisional Application Ser. No. 60/610,313 filed Sep. 16, 2004.

### FIELD OF THE INVENTION

The present invention relates generally to the electronic generation of trade agreements and more specifically is directed to agreements between multiple parties including one or more credit providers.

### BACKGROUND OF THE INVENTION

In existing systems, online electronic trading systems provide for the generation of trade agreements between a buyer and a seller. Through the central trading system, available across a networked connection, trade agreements may be entered into without the procurement of letters of credit.

Existing trading systems allow for a buyer and a seller to enter into business agreements relating to the trade of goods and services. The existing systems typically utilize a network based connection allowing a buyer and a seller to conduct the contractual transaction within a central trade system. Through this trade system, the speed of the procurement of goods and service is significantly improved through the replacement of previously utilized letters of credit (“LOC”). With the electronic trading system, previously time consuming tasks are managed within a centrally accessible electronic trading system.

Full Service Trade Systems and improvements thereon are described in U.S. Pat. No. 5,717,989, issued on Feb. 10, 1998; U.S. Pat. No. 6,151,588, issued on Nov. 21, 2000; U.S. patent application Ser. No. 09/981,616 filed on Oct. 16, 2001; U.S. patent application Ser. No. 09/981,637 filed on Oct. 16, 2001; U.S. patent application Ser. No. 09/981,645 filed on Oct. 16, 2001; U.S. patent application Ser. No. 09/981,642 filed on Oct. 16, 2001; and Patent Cooperation Treaty International Application No. PCT/US01/32379, filed on Oct. 16, 2001 and published as W.I.P.O. Publication No. WO 02/33514, collectively referred to as “Related Patents and Applications”.) The Related Patents and Applications are herein incorporated by reference in each of its entirety.

Currently, the trade systems allow for transactions specifically between the buyer and seller. The transactions include negotiating terms of a contract, amending purchase order agreements, allowing either the buyer or seller to obtain insurance on aspects of the transaction and many other features. Although, these transaction are specifically between buyer and the seller.

In these trade systems, the buyer and seller qualify with a funder such that upon approval, account parameters are established for the parties to engage in business. The prospective purchase agreements negotiated or entered into include a payment guarantee provided by the funder. Through the funder, the buyer and seller can readily engage in business activity without the use of the previously complicated LOC system because the funder insures payment if the buyer does not pay.

Although, in these systems the buyer and seller may not wish to utilize the funder, but rather uses one or more third party credit providers. With the current marketability and business advantage of credit providers offering different types of credit systems, there exists a need for, among of things, an electronic trade system wherein the buyer may acquire and utilize a line of credit from one or more third party credit providers.

### BRIEF DESCRIPTION OF THE DRAWINGS

FIG. 1 illustrates one embodiment of an electronic trading system including credit providers;

FIG. 2 illustrates another embodiment of an electronic trading system including credit providers;

FIG. 3 illustrates another embodiment of an electronic trading system including credit providers;

FIG. 4 illustrates a flowchart of the steps of one embodiment of an electronic trade servicing method;

FIG. 5 illustrates a flowchart of the steps of another embodiment of the electronic trade servicing method;

FIG. 6 illustrates a flowchart of the steps of another embodiment of the electronic trade servicing method;

FIG. 7 illustrates a flowchart of the steps of another embodiment of the electronic trade servicing method;

FIG. 8 illustrates a flowchart of the steps of another embodiment of the electronic trade servicing method;

FIG. 9 illustrates a flowchart of the steps of another embodiment of the electronic trade servicing method;

FIG. 10 illustrates a flowchart of the steps of another embodiment of the electronic trade servicing method; and

FIG. 11 illustrates a flowchart of the steps of another embodiment of the electronic trade servicing method.

### DETAILED DESCRIPTION

Generally, the electronic trade service device includes processing devices, which may be one or more processors or electronic elements providing a specific computational function for providing negotiation and resolution of a commercial agreement between a buyer and seller. The agreement includes defined contract terms relating the underlying transaction. The device includes operating features providing for securing electronic connections by the buyer and seller to an electronic trade system.

In this trade system, the contract terms between the buyer and seller are specifically and electronically defined, including defining a price term and a payment term. Furthermore, within this trade service device, the buyer is associated with one or more credit providers, which may be any type of entity providing for the lending or pledging of financial support based on defined terms.

Within the trade system, the agreement is thereupon finalized including the pledging of at least a portion of the line of credit relating to the price term for securing payment by the buyer to the seller in exchange for producing the contractual items. Therefore, the buyer utilizes a line of credit provided by one or more credit providers so that the commercial agreement between the buyer and seller is now secured not by a funder associated with the trade system, but a third party credit provider accessible through the trade system. This allows for the buyer to choose from an array of credit options for conducting business transactions. As discussed in further detail below, there also exits other improvements relating to the trade system allowing the buyer and seller further flexibility in the conducting of commercial transactions.

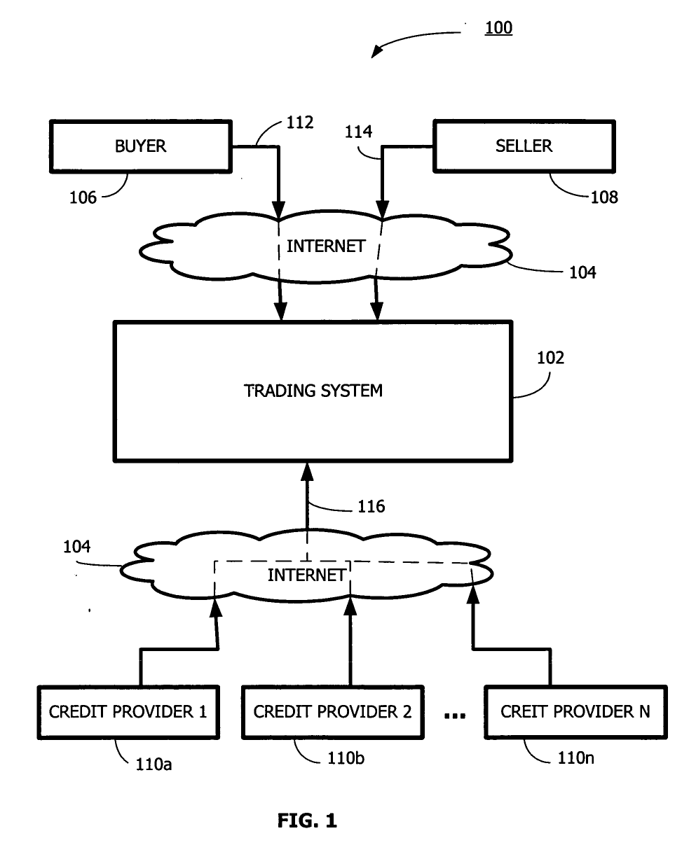

More specifically, FIG. 1 illustrates one embodiment of an online electronic trading system 102. The system 102 may be disposed on one or more server accessible through the internet 104. The system 102 is accessible by a buyer 106 and a seller 108, wherein the buyer 106 and seller 108 may use computing devices accessing the internet 104 and being subsequently routed to the trading system 102.

The system 102 is further accessible by a number of credit providers 110a-110n. Illustrated in FIG. 1 are a first credit provider 110a, a second credit provider 110b, and an n-numbered credit provider 110n, where n represents any suitable number. Illustrated herein, any suitable number of credit providers 110 may access the trading system 102, typically through the internet 104, but the connection may be through any other connection, such as for example an intranet or other private network.

In accordance with systems described in the related applications, the buyer 106 and seller 108 engage in commercial transactions relating to particular goods or services. Although, in the trade system 102, the credit providers 110 may be utilized to provide a specific line of credit to the buyer 106 for the transactions.

As described in further detail below, the buyer 106 creates a connection 112 with the trading system 102, such as through a first input device (not shown). The seller 108 creates a connection 114 with the trading system 102, such as through a second input device (not shown). The buyer 106 and seller 108 perform operations relating to commercial transactions within the trading system 102. Although, the credit providers 110 create a connection, shown collectively and generally at 116, with the trading system 102 for providing the credit-related services.

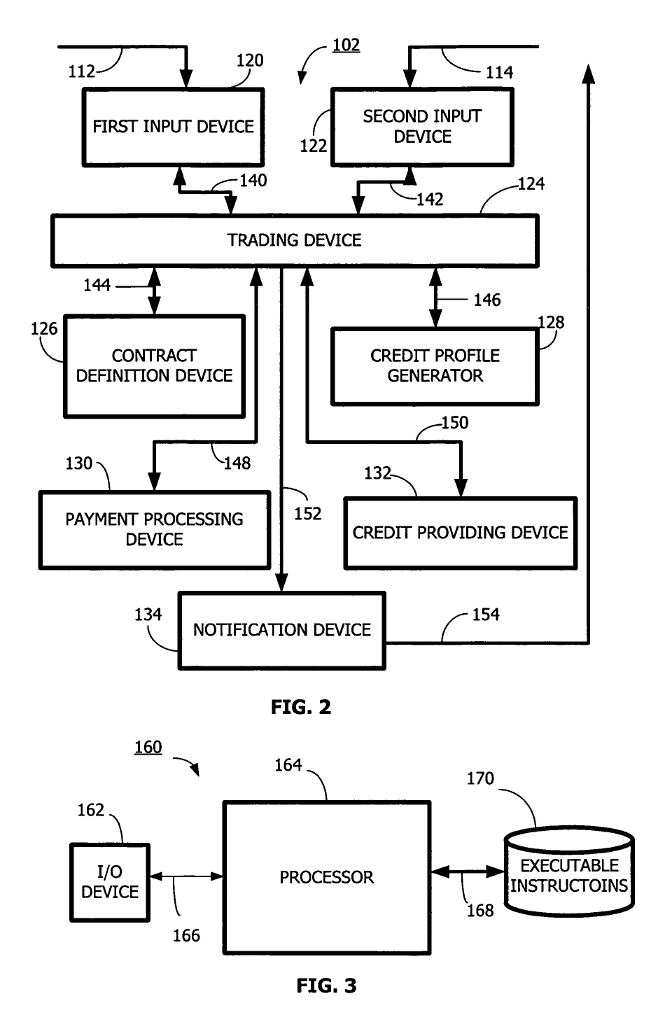

FIG. 2 illustrates one embodiment of the trading system 102 including a first input device 120, a second input device 122, a trading device 124, a contract definition device 126, a credit profile generator 128, a payment processing device 130, a credit providing device 132 and a notification device 134. These devices may be hardware device including hardware components for the performance of prescribed functionality. These device may also be hardware including processing elements for performing the prescribed functionality, such as an application specific integrated circuit. These devices may also be separate or within one or more large processing elements, as recognized by one having ordinary skill in the art.

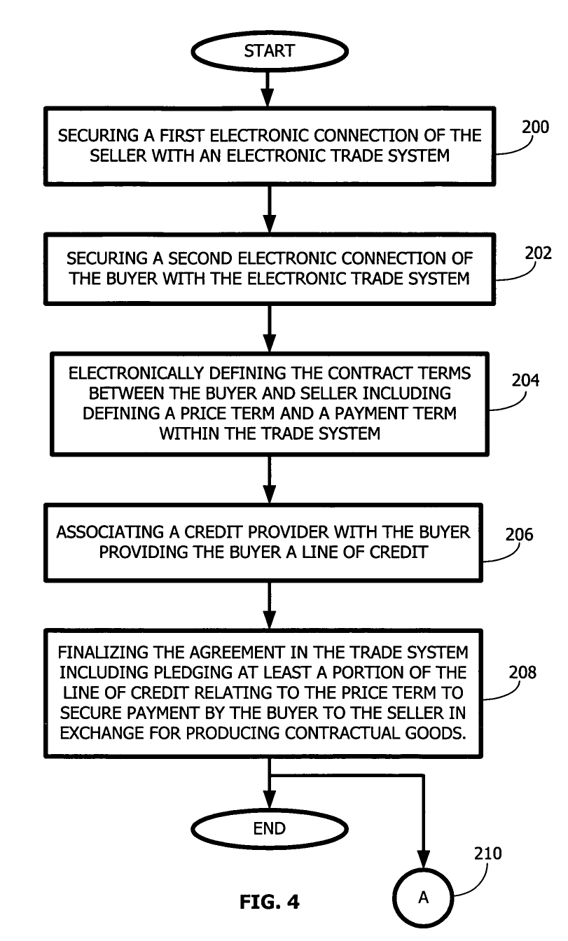

For the sake of brevity, the general structure of this embodiment of the trading system 102 is described herein and the associated functionality of these elements is described in further detail with respect to the flow chart of FIGS. 4-11 as applicable.

The first input device 120 receives the connection 112 from the buyer (106 of FIG. 1) and the second input device 122 receives the connection 114 from the seller (108 of FIG. 1). The input devices 120 and 122 are coupled to the trading device 124 via connections 140 and 142, respectively, such as across a data bus or other type of connection.

Similarly, the contract definition device 126 is coupled to the trading device via connection 144 such that the buyer and seller may negotiate to define contract terms using the contract definition device 126. This device may include input/output processing function allowing the buyer and seller to negotiate different terms and thereby define the terms of the agreement.

The credit profile generator 128 is coupled to the trading device 124 via connection 146 such that one or more credit profiles may be generated. The credit profiles typically relate to a buyer's current credit status, including typical credit information. For example, the profile may include the amount of available credit the buyer has, the buyer's credit rating or credit score, the buyer's total credit line, the buyer's credit history and other information. It is also noted that the credit profile generated by the generator 128 may be related to any of the parties that use credit within the trading system, including credit providers 110, sellers 108, insurance underwriters, a funder or a vendor, for example. It is further noted that available credit and credit profiles may also related to a buyer and any related entities, such as for example a legal subsidiary.

The payment processing device 130 is coupled to the trading device 124 via connection 148 such that a payment may be processed between two or more parties. This processing may be through existing clearinghouse systems, through third party processing systems or direct transactions such as a wire transfer to designated accounts. The processing device 130 receives information including to which parties payments are to be processed and facilitates such payments. In one embodiment, the device 130 may include access to particular financial accounts or in another embodiment may simply reference accounts, such as directing third parties to conduct payment transactions.

The credit providing device 132 is coupled to the trading device 124 via connection 150. The credit providing device 132 facilitates the extension of certain amounts of credit to particular parties. This device 132 may be an automated device whereas an entity, e.g. buyer or seller, having specific qualifications are provided a line of credit based on preset terms. In another embodiment, the device 132 may include interaction from one or more credit providers authorizing a particular line of credit at defined terms. The device 132 thereupon associates this credit with the corresponding entity, typically stored within the trading device 124 so that this information may be readily available, such as for use by the credit profile generator 128.

The notification device 134 is coupled to the trading device 124 via connection 152. The notification device 152 generates a notification 154 that is provided to an entity, as instructed. For example, in one embodiment the notification device 134 may include generating an electronic mail notification that is then sent to a buyer, seller, credit provider or other entity. In another embodiment, notification may be transmitted through the trading device 124, for example when a recipient connects to the trading device 124, the notification is provided at that time. Regardless of the technique, the device 134, in response to instructions either from or through the trading device 124 provides a specific notification to an intended recipient.

It is also noted that the above-described devices 120, 122, 124, 126, 128, 130, 132 and 134 may be, in one embodiment, one or modules implemented in software executed on one or more processing device for performing the specified operations.

FIG. 3 illustrates another embodiment of an electronic trade servicing device 160. The device 160 includes an input/output device 162 for the communication of various parties with a processor 164 via connection 166. The input/output device 162 may be accessed across a network connection using known protocol and data transmission techniques and interaction is therein facilitated with the processor 164.

The processor 164 of the device 160 may be one or more processing devices, such as a general processor performing executable instructions 168 received from a memory device 170. The processor 164 may also be one or more application specific processors for performing designated functions. The processing device 160 thereupon performs operations for facilitating the negotiation and resolution of a commercial agreement between a buyer and a seller, including one or more credit providers, as discussed in further detail in the flow charts below.

FIG. 4 illustrates a flowchart having steps providing for one embodiment of a method for an electronic trade service. These steps may be performed by the trading system 102 of FIGS. 1 and 2 and they may also be performed by the processor 164 of FIG. 3. The method begins by securing a first electronic connection of the seller with an electronic trade system, step 200. The first secure connection may be created through the first input device 120. The secure connection may include a login screen or other verification technique, such as a public/private key function or dedicated smart card identification system. This secure connection insures the integrity of communications between the buyer 106 and the trading device 102.

The second step, step 202, is securing a second electronic connection of the buyer with the electronic trade system. This secure connection may be acquired through the second input device 122, such as using similar techniques utilized in step 200. This step insures integrity of the communication of seller 108 with the trading device 102. In another embodiment, steps 200 and 202 may be performed through the input/output device 162 of FIG. 3 for communication with the processor 164.

The next step, step 204, is electronically defining the contract terms between the buyer and seller including defining a price term and payment term within the trade system. Step 204 may be performed using the contract definition device 126 using known techniques for generating the contract. Step 204 may be executed using techniques as disclosed in the Related Applications. This step may also be performed by the processor 160 in response to the executable instructions 168. Thereupon, the agreement is generated between the buyer and seller, the agreement having numerous defined terms, including price terms and delivery terms.

The next step, step 206, is associating a credit provider with the buyer so the credit provider provides the buyer with a line of credit. In the embodiment described in FIG. 2, the credit providing device 132 associates a buyer with a corresponding credit provider. In one embodiment, there may include existing relationships between the buyer and one or more credit providers such that the credit is associated based on this existing relationship. In another embodiment, predefined criteria may be used to associate the buyer with credit providers, for example criteria relating to the buyer creditworthiness or similar factors. In another embodiment, the buyer may utilize the credit processing device 132 to request or search for credit from one or more credit providers, such as an application process or a review of the credit provider's current credit-line term offerings. As noted above, credit available to a buyer may also be credit available to entities related to the buyer. Step 206 may also be performed by the processor 164 of FIG. 3.

The next step, step 208, is finalizing the agreement in the trade system including pledging at least a portion of the line of credit relating to the price term to secure payment by the buyer to the seller in exchange for producing contractual goods or services. Previous systems utilized underwritten guarantees, the pledged credit by the credit provider thereupon shifts the payment burden. In this embodiment, upon satisfaction of contractual obligations, the credit provider is obligated to pay the seller instead of a funder that insures payment should the buyer default. Thereupon, in this embodiment the financial burden is shifted to the credit provider and the buyer's burden is repayment to the credit provider, thereby providing a greater degree of assurance to seller for payment from a credit provider over the buyer. Step 208 may be performed by the trading device 124 based on the information from the contract definition device 126 and the credit providing device 132. Step 208 may also be executed in the processor 164 in response to one or more software performing the steps as discussed above. Alternative embodiments of this method may include further steps indicated beyond marker A 210. Although, in this embodiment, the method for electronic trade servicing is complete.

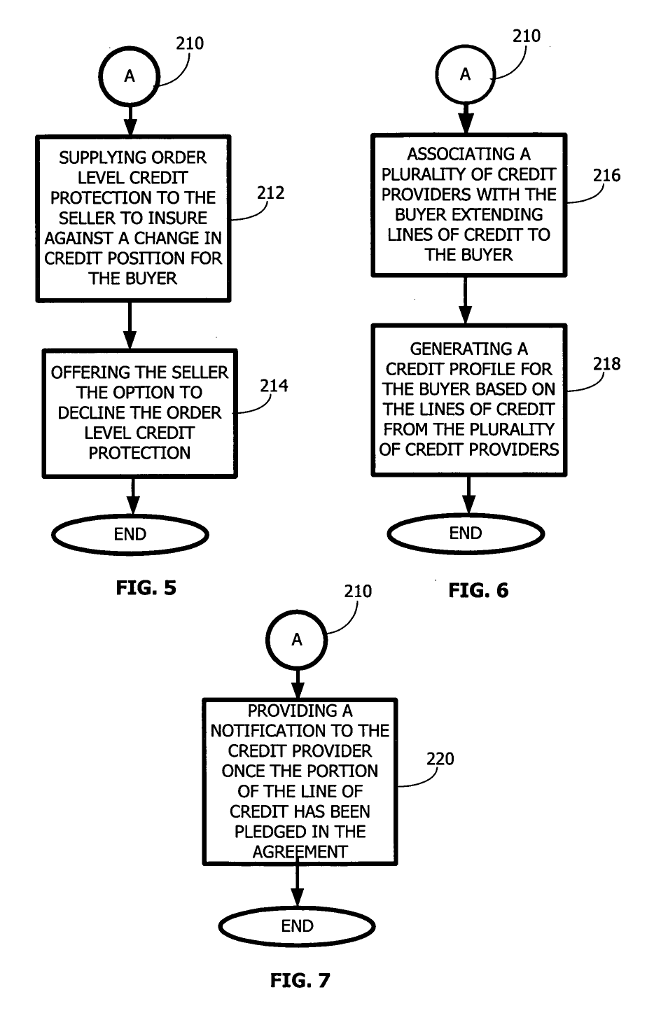

FIG. 5 illustrates another embodiment of the method of FIG. 4 including the additional steps after marker A 210 proceeding step 208 in FIG. 4. The embodiment of the method of the flowchart includes steps 200, 202, 204, 206 and 208 as discussed above with respect to FIG. 4. The next step of the method is step 212, supplying order level credit protection to the seller to insure against a change in credit position for the buyer.

Order level credit protection may cover the full amount of a particular order for a period beginning on an order approval date and ending at a period of time after the latest shipment date of the order. This protects the seller against any risk of the Buyer's limit being downgraded, but the seller will pay for the full duration of coverage, starting on the Order Approval Date. The seller generally pays a fee based on the amount of the invoice, but the full time-frame of the coverage is locked against the order. When the seller selects Order-Level protection on a payment quote, the full value of the purchase order is blocked against the buyer's credit line. Invoices created against the order draw down against the amount of coverage assigned to the order. When each invoice is paid, the invoice amount is returned to the buyer's credit line use against future transactions.

In one embodiment, if a buyer's credit profile is flagged as using indicative reserves, and these reserves are used for a buyer's transactions, the coverage is reserved against the buyer's credit limit when the buyer approves the purchase order instead of when the seller approves the payment protection quote.

The next step, step 212, is offering the seller the option to decline the order level credit protection. This step may be performed by the trading device 124 including functionality for presenting the seller with the terms of the order level credit protection. The device 124 may also provide other information usable by the seller in making the determination, such as an indication of the buyer's creditworthiness, a listing of the buyer's outstanding debts, an indication of the buyer's payment history, and any other suitable information.

When a seller receives a purchase order, the proof of payment protection will be situated in an order folder with a status of “indicative.” Once the order document has an active status, a payment protection quote will still be directed to the seller for them to complete. If the seller selects order-level credit protection, the existing proof will receive an active status. If the seller selects invoice-level or no protection, the indicative proof will get deleted and the amount of coverage will get returned to the buyer's line.

Steps 212 and 214 may also be performed by the processing device 164 providing the input and output communication with the seller through the input/output device 162. Therefore, in this embodiment, the method is complete.

FIG. 6 illustrates another embodiment of a method for electronically servicing trading using a trading system. This embodiment includes previously discussed steps of FIG. 4 and continues with respect to marker A 210. The next step, step 216 is associating a plurality of credit providers with the buyer to extend lines of credit to the buyer. This step may be performed by electronically allocating funds or available credit to the buyer's account. This may also include updating a credit database that the buyer may access prior to finalizing the business agreement.

The next step, step 218, is generating a credit profile for the buyer based on the lines of credit from the credit providers. This step may be performed by the credit profile generator 128 of FIG. 2 wherein the information associated with the buyer and the status of the buyer's credit situation, for example the total credit granted to the buyer and the amount of available credit, as well as possibly an indicator of which credit providers carry the associated risk.

In one embodiment, step 216 may include pledging varying amounts of credit from different credit providers. For example, one credit provider may offer credit on preferred terms so the buyer prefers one or more credit over others. In another embodiment, the credit may be pledged proportional to each credit provider's pro-rated share of the available credit. In this embodiment, if particular credit provider provides 25 percent of the buyer's total available credit, when credit is pledged, 25 percent of the pledged credit is allocated to the particular credit provider.

It is also noted that the steps of this embodiment may be performed by the processing device 164 in response to executable instructions 168, with the buyer, seller and credit providers accessing the processor 164 through the input/output device 162. As such, this embodiment of this method is complete.

FIG. 7 illustrates another embodiment of a method for electronically servicing trading using a trading system. This embodiment includes previously discussed steps of FIG. 4 and continues with respect to marker A 210. The next step, step 220, includes providing a notification to the credit provider once the portion of the line of credit has been pledged in the agreement. This step may be performed by the notification device 134 of FIG. 2 or by the processor 164 of FIG. 3. In one embodiment, this notification may be via electronic mail, whereas there exists any suitable number of various techniques for notifying the credit provider within the scope of this method, as recognized by one having ordinary skill in the art.

Different types of notifications may be generated. For example, an active indicative proof message may be generated once an indicative proof of order payment protection is created. In another example, an active payment protection quote message may be generated when the payment protection quote becomes active. A rejected purchase order message may be generated when the purchase order is cancelled or rejected by the buyer or the seller. A purchase order amendment message may be generated when both the buyer and seller have approved a purchase order amendment that results in a change in any specific terms, such as payment terms, purchase order amount or shipment dates. A payment authorization creation message may be generated when a payment authorization is created and this message informs whether the transaction has passed data compliance. A payment authorization notification is generated once payment has been authorized and similarly, a payment authorization rejection may be generated once a payment authorization is rejected. Once the notification has been transmitted, this embodiment is complete.

FIG. 8 illustrates another embodiment of a method for electronically servicing trading using a trading system. This embodiment includes previously discussed steps of FIG. 4 and continues with respect to indicator A 210. The next step, step 222, includes generating a credit profile for the seller based on the pledged portion of the line of credit. This step may be performed similar to step 218 discussed with respect to FIG. 6. The next step, step 224, includes making the credit status of the buyer available for inspection by the plurality of credit providers. This step may include allowing parties to access the trading system and viewing this information with a designated location in the system. In another embodiment, the information may be broadcast to the parties based on associated relationships, for example a credit provider may receive information about all parties that it extends credit to, such as through the notification device 134.

In some embodiments, buyers may have different divisions within a company, each with their own purchasing department. Accordingly, these may be set up as different organization. Depending on the relationship of these organizations, coverage providers may want to assign one limit to all of these subsidiaries instead of separate limits to each subsidiary. To achieve this effect, multiple organizations in the system may be linked to one credit profile. The credit profile is the business object that contains all of the credit limit and business rules applicable to the credit line given to the buyer. When a transaction is evaluated for its credit worthiness under a buyer's line, it will not be evaluated against all transaction under the given organization, but rather all transactions that are booked against the specific credit profile, regardless of the organization originating the transaction.

Many seller members have different divisions as well, and the transactions between the multiple divisions and a given Buyer may need to be treated as transactions between one company for credit models that have the concept of a relationship limit. To achieve this effect, a new identifier may be used to link all seller organizations. When the system evaluates all transactions booked under the relationship (Buyer and Seller), it will look to all transactions that use the shared seller identity, regardless of the actual seller organization identifier in the system, to determine if the relationship limit has been reached.

To achieve this effect, one embodiment utilizes a flag on the credit profile that indicates whether or not the coverage provider funds the account. If the answer is “True” on the profile, the profile must also contain the account of the credit provider that will be used for all transactions being booked against the credit profile. When invoices are created against the order that is covered by a credit profile that has a credit provider account on it, it will be the credit provider's account that is debited on the scheduled date, according to the terms of the order. Accordingly, the credit provider will be able to receive all payment messages and emails.

This credit status information therefore may be usable by one or more credit providers in extending or monitoring a line of credit. Similarly, the credit status information may be used by the seller to assess the buyer's situation prior to entering into an agreement. In one embodiment, access to this information may be through one or more layers of security to protect the buyer or seller. The steps of this embodiment may be performed by the trading system 100 of FIG. 2 or the processor 164 of FIG. 3. As such, this embodiment of the method is complete.

FIG. 9 illustrates another embodiment of a method for electronically servicing trading using a trading system. This embodiment includes previously discussed steps of FIG. 4 and continues with respect to marker A 210. The next step, step 226 includes transferring a discounted payment to the seller from the buyer prior to an agreed upon payment date. The payment may be facilitated by the payment processing device 130 of FIG. 2. In this embodiment, the discounted payment satisfies the payment obligations under the agreement and the discount payment represents an adjustment in the price term reflective of a time period between payment of the discounted payment and the payment date. For example, the agreement may include a payment period where upon completing a particular task, e.g. shipping the goods, the buyer must make a payment within 45 days. The seller may then accept a pro-rated payment in exchange for an earlier payment. The discount payment reflects the seller's willingness to take a reduced payment earlier in time, providing a greater degree of flexibility for all parties to the transaction. The steps of this embodiment may be performed by the trading system 102 of FIG. 2 or the processor 164 of FIG. 3. As such, this embodiment of the method is complete.

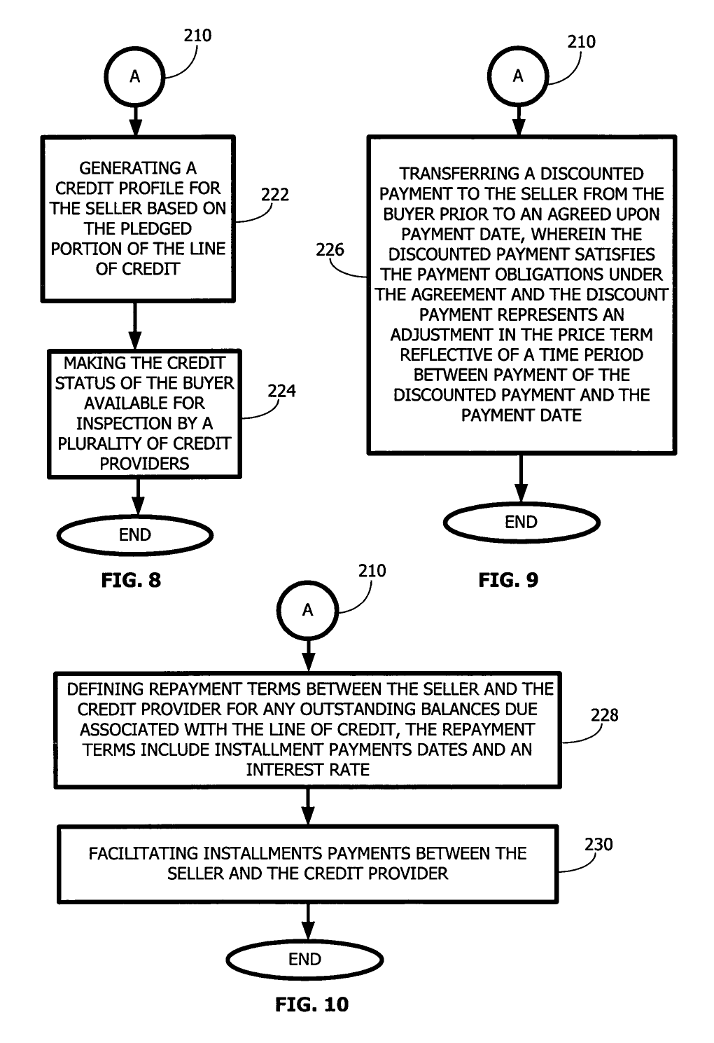

FIG. 10 illustrates another embodiment of a method for electronically servicing trading using a trading system. This embodiment includes previously discussed steps of FIG. 4 and continues with respect to marker A 210. The next step, step 228, is defining repayment terms between the buyer and the credit provider for any outstanding balance due associated with the line of credit. The repayment terms include installment payment dates and an interest rate. The next step, step 230, is facilitating installment payments between the buyer and the credit provider over the defined period, in essence providing the buyer with an installment loan to repay the monies due under the credit agreement with the credit provider. This step may be performed by the trading deice 124 carrying out operations with the payment processing device 120 or the processor 164 of FIG. 3. As such, this embodiment of the method is complete.

Similarly, in another embodiment of the method of FIG. 10, the line of credit is pledged to the seller for payment at a time relating to a particular step. A step may be, for example development of a particular good or the delivery of a good or service. When the seller verifies completion of a defined task at the particular step and at least one of, the credit provider or the buyer thereupon authorizes payment to the seller

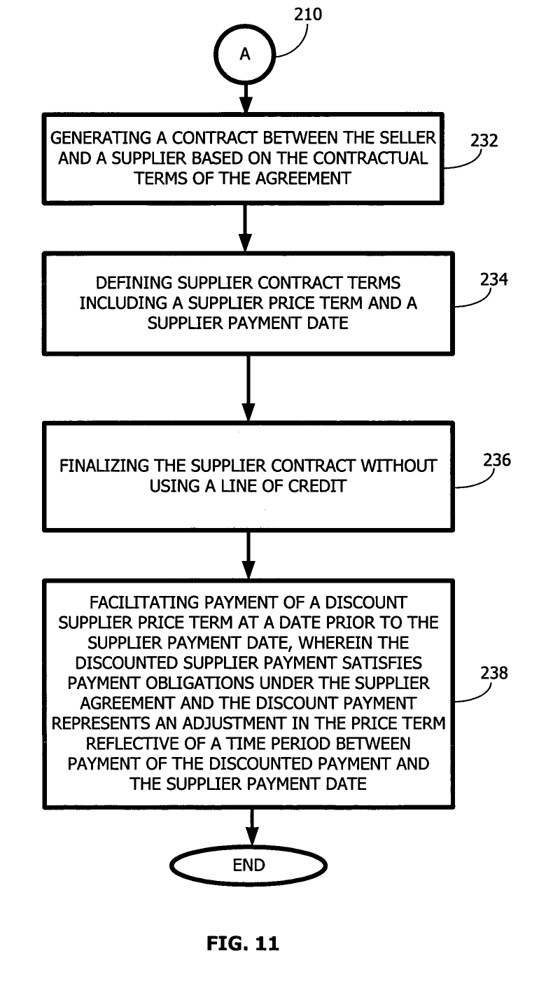

FIG. 11 illustrates another embodiment of a method for electronically servicing trading using a trading system. This embodiment includes previously discussed steps of FIG. 4 and continues with respect to indicator A 210. The next step, step 232, is generating a contract between the seller and a supplier based on the contractual terms of the agreement. The supplier is typically an entity that the seller uses to acquire components for assembly, such as raw materials or other materials utilized in providing contracted goods to the buyer.

The next step, step 234, is defining supplier contract terms including a supplier price term and a supplier payment date. This step may be similar to the contract term definition process performed by the buyer and seller and may be performed within the trade system 102 of FIG. 1. The next step, step 236, is finalizing the supplier contract without using a line of credit. In this step, the seller contracts for direct payment to the supplier so that any credit profile or credit structure the seller may have from one or more credit providers is unaffected. This allows for a more streamlined process between the seller and the supplier as credit providers are not included in the process.

The next step, step 238, is to facilitate payment of a discount supplier price term at a date prior to the supplier payment date. The discounted supplier payment satisfies payment obligations under the supplier agreement and the discount payment represents an adjustment in the price term reflective of a time period between payment of the discounted payment and the supplier payment date. Similar to the pre-payment technique of embodiment of FIG. 9, the pre-payment reflects a reduced payment amount for the earlier receipt of the funds. The payment may be facilitated through the payment processing device 130 of FIG. 2 or within a processing routine of executable instructions 168 within the processor 164. Therefore, the trading system 102 allows for the seller to conduct transactions with suppliers including the seller utilizing its financial resources and benefiting from pre-payment options with the supplier. As such, this embodiment of the method is complete.

Therefore, through various enhancements, the electronic trading system provides improved trading features. In some embodiments, the invention provides enhancements relating to the flexibility, for example, for sellers or other parties to reserve credit protection, assurance, or coverage in relation to a purchase order prior to creation or generation of an invoice. For example, a seller may wish for, and be willing to pay for, the ability to reserve credit protection at such a stage in order to lock in coverage without regard to possible future changes in the buyer's credit situation.

In some embodiments, the invention(s) provides enhancements relating to sellers or other parties with an option to elect not to take or purchase any coverage or credit protection with respect to a transaction. In some embodiments, the invention(s) includes enhancements to provide flexibility with regard to accommodating various different credit or coverage providers, such as banks, and different credit models. For example, in some instances, a buyer may have a line of credit with two or more different credit providers or assurors, each with a different credit model. This flexibility allows different buyers to use the credit provider and credit model that is acceptable or most appropriate for the particular seller, or to provide the trade system with criteria or logic with which to make such a determination. In some embodiments, a credit provider can customize the trade system to limit or restrict credit-related options available for certain buyers.

In some embodiments, the invention(s) includes enhancements providing capabilities with regard to messaging, including messages such as e-mails that may be provided to credit providers. For example, the trade system may send a message to a credit provider when a buyer's line or amount of coverage changes, whether by increasing or decreasing, as a result, for example, of developments relating to transactions accomplished using the trade system. In some embodiments, credit providers can cause the trade system to send messages when credit coverage is allocated, including the time and amount of the allocation, as well as messages relating to payment or draw-down of coverage, or cancellation of coverage.

In some embodiments, the invention(s) includes enhancements providing a trade system with a capability to perform credit profile sharing functions. For example, a buyer may be included or listed in connection with several different business areas or markets facilitated using the trade system, yet orders of the buyer are all to be booked against the same credit line, such a company-wide credit line. To accommodate such situations, the buyer's credit profile is shared throughout different areas or listing within the trade system. In some embodiments, the invention(s) includes enhancements providing the flexibility for credit providers to make arrangements such that, for a particular transaction, it is the credit provider's account which is debited, rather than the buyer's account. In some instances, the buyer is debited outside the trade system to pay the credit provider.

In some embodiments, the invention(s) include enhancements providing flexibilities and capabilities relating to financing in connection with transactions. In such embodiments, parties to transactions benefit from the ability of the trade system to integrate all of the parties to the transaction, including buyer, seller, and credit provider or financing providers. Furthermore, the trade system can integrate and handle together several related transactions, including a buyer/seller transaction as well as a related financing provider buyer or financing provider/seller transaction, which otherwise might need to be handled more separately and less efficiently. Additionally, financing providers, such as banks, can benefit through use of the trade system from a more secure and informed process and system than would be available if financing arrangements were made independently of an underlying buyer/seller transaction, or in a less integrated fashion than is provided by the trade system.

Furthermore, capabilities and advantages of the trade system generally are enjoyed, including improved or more efficient speed, improved workflow capabilities, transparency or visibility, communication, integration and comprehensiveness with regard to aspects of transactions and groups of transactions and also with regard to parties to transactions, the trade system itself performing comparisons and determinations based on input criteria or logic and taking action accordingly, and other benefits. In some embodiments, transactions involving financing can also include allowing the trade system to select a financing provider to provide financing based on criteria or logic provided to the system by, for example, buyers or sellers. Transactions can also include the trade system making a determination as to whether to proceed to arrange financing between parties, based on criteria provided by parties.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An electronic trade servicing method providing for the negotiation and resolution of a commercial agreement between a buyer and a seller, the agreement having contract terms, the method comprising:
securing a first electronic connection of the seller with an electronic trade system;
securing a second electronic connection of the buyer with the electronic trade system;
electronically defining the contract terms between the buyer and seller including defining a price term and a payment term within the trade system;
associating a credit provider with the buyer providing the buyer a line of credit; and
finalizing the agreement in the trade system including pledging at least a portion of the line of credit relating to the price term to secure payment by the buyer to the seller in exchange for producing contractual items.

2. The electronic trade servicing method of claim 1 further comprising:
supplying order level credit protection to the seller to insure against a change in credit position for the buyer.

3. The electronic trade servicing method of claim 2 further comprising:
offering the seller the option to decline the order level credit protection.

4. The electronic trade servicing method of claim 1 further comprising:
associating a plurality of credit providers with the buyer extending lines of credit to the buyer; and
generating a credit profile for the buyer based on the lines of credit from the plurality of credit providers.

5. The electronic trade servicing method of claim 4 wherein the step of pledging the at least a portion of the line of credit includes pledging varying amount of credit from different credit providers.

6. The electronic trade service method of claim 4 wherein the step of pledging the at least a portion of the line of credit includes pledging amount of credit proportional to the credit providers share of the buyer's credit profile.

7. The electronic trade service method of claim 1 further comprising:
providing a notification to the credit provider once the portion of the line of credit has been pledged in the agreement.

8. The electronic trade service method of claim 7 wherein the notification is transmitted using an electronic mail communication.

9. The electronic trade service method of claim 1 further comprising:
generating a credit profile for the seller based on the pledged portion of the line of credit; and
making the credit status of the buyer available for inspection by a plurality of credit providers.

10. The electronic trade service method of claim 9 wherein the credit status is usable by one or more credit providers prior to extending a line of credit.

11. The electronic trade service method of claim 9 wherein the credit status is usable by the seller prior to entering into the agreement.

12. The electronic trade service method of claim 1 further comprising:
transferring a discounted payment to the seller from the buyer prior to an agreed upon payment date, wherein the discounted payment satisfies the payment obligations under the agreement and the discount payment represents an adjustment in the price term reflective of a time period between payment of the discounted payment and the payment date.

13. The electronic trade service method of claim 1 further comprising:
defining repayment terms between the seller and the credit provider for any outstanding balances due associated with the line of credit, the repayment terms include installment payments dates and an interest rate; and
facilitating installments payments between the seller and the credit provider.

14. The electronic trade service method of claim 1 wherein the line of credit is pledged to the seller for payment at a time relating to a particular step in at least one of:
development and delivery, of the contractual goods such that a seller verifies completion of a defined task at the particular step and at least one of: the credit provider and buyer authorizes payment to the seller.

15. The electronic trade service method of claim 1 further comprising:
generating a contract between the seller and a supplier based on the contractual terms of the agreement;
defining supplier contract terms including a supplier price term and a supplier payment date;
finalizing the supplier contract without using a line of credit; and
facilitating payment of a discount supplier price term at a date prior to the supplier payment date, wherein the discounted supplier payment satisfies payment obligations under the supplier agreement and the discount payment represents an adjustment in the price term reflective of a time period between payment of the discounted payment and the supplier payment date.

16. An online electronic trading system providing for the electronic negotiation and resolution of a commercial agreement between a buyer and a seller, the agreement having contract terms, the trading system including:
a trading device operative to store commercial agreements and facilitate transactions relating to the execution of steps by the buyer and seller to satisfy conditions of the agreements;
a first input device coupled to the trading device receiving a first connection request from the seller and electronically connecting the seller to the trading device;
a second input device coupled to the trading device receiving a second connection request from the buyer and electronically connecting the buyer to the trading device;
a contract definition device associated with the trading device defining the contract terms between the buyer and seller including defining a price term and a payment term within the trade system;
a credit providing device associated with the trading system associating a credit provider with the buyer providing the buyer a line of credit; and
the trading device operative to finalize the agreement including pledging at least a portion of the line of credit relating to the price term to secure payment by the buyer to the seller in exchange for producing contractual items.

17. The online electronic trading system of claim 16 further comprising:
the credit providing device operative to grant order level credit protection to the seller to insure against a change in credit position of the buyer.

18. The online electronic trading system of claim 17 wherein the credit protection device provides an offer to the seller to decline the order level credit protection.

19. The online electronic trading system of claim 16 further comprising:
the credit providing device operative to associate a plurality of credit providers to provide lines of credit to the buyer; and
a credit profile generator operative to generate a credit profile for the buyer based on the lines of credit from the plurality of credit providers.

20. The online electronic trading system of claim 19 wherein the pledged at least a portion of the line of credit is pledged in varying amounts from the credit of the credit providers.

21. The online electronic trading system of claim 19 wherein the pledged portion of the line of credit is pledged proportional to a credit provider's share of the buyer's credit profile.

22. The online electronic trading system of claim 16 further comprising:
a notification device operative to provide a notification to the credit provider once the portion of the line of credit has been pledged in the agreement.

23. The online electronic trading system of claim 22 wherein the notification is transmitted using an electronic mail communication.

24. The online electronic trading system of claim 16 further comprising:
a credit profile generator operative to generate a credit profile for the buyer based on the pledged portion of the line of credit, wherein the credit profile is viewable by the least one credit provider.

25. The online electronic trading system of claim 24 wherein the credit profile is viewable prior to extending the line of credit through the credit providing device.

26. The online electronic trading system of claim 24 wherein the credit profile is viewable by the seller prior to the trading device finalizing the agreement between the buyer and seller.

27. The online electronic trading system of claim 16 further comprising:
a payment processing device operative to transfer a discounted payment to the seller from the buyer prior to an agreed upon payment date, wherein the discounted payment satisfies the payment obligations under the agreement and the discount payment represents an adjustment in the price term reflective of a time period between payment of the discounted payment and the payment date.

28. The online electronic trading system of claim 16 wherein the trading device is operative to define repayment terms between the seller and the credit provider for any outstanding balances due associated with the line of credit, the repayment terms include installment payments dates and an interest rate, the system further comprising:
a payment processing device operative to facilitate installments payments between the seller and the credit provider.

29. The online electronic trading system of claim 16 wherein the line of credit is pledged to the seller for payment at a time relating to a particular step in at least one of:
development and delivery, of the contractual goods such that a seller verifies completion of a defined task at the particular step, the system further comprising:
a payment processing device operative to authorize the transfer of funds for a payment to the seller from at least one of: the credit provider and buyer.

30. The online electronic trading system of claim 1 further comprising:
the contract definition device operative to define the contract terms between the buyer and seller including defining a price term and a payment term;
the trading device operative to generate a contract between the seller and a supplier based on the contractual terms of the agreement;
the contract definition device operative to define supplier contract terms including a supplier price term and a supplier payment date;
the trading device operative to finalizing the supplier contract without using a line of credit; and
a payment processing device operative to facilitate payment of a discount supplier price term at a date prior to the supplier payment date, wherein the discounted supplier payment satisfies payment obligations under the supplier agreement and the discount payment represents an adjustment in the price term reflective of a time period between payment of the discounted payment and the supplier payment date.

31. An electronic trade servicing device comprising:
a process device facilitating the negotiation and resolution of a commercial agreement between a buyer and a seller, the agreement having contract terms, the processing device, in response to executable instructions, operative to:
secure a first electronic connection of the seller with;
secure a second electronic connection of the buyer;
electronically define the contract terms between the buyer and seller including defining a price term and a payment term;
associate a credit provider with the buyer providing the buyer a line of credit; and
finalize the agreement including pledging at least a portion of the line of credit relating to the price term to secure payment by the buyer to the seller in exchange for producing contractual items.

32. The electronic trade servicing device of claim 31, the processing device further operative to:
supply order level credit protection to the seller to insure against a change in credit position for the buyer.

33. The electronic trade servicing device of claim 32, the processing device further operative to:
offer the seller the option to decline the order level credit protection.

34. The electronic trade servicing device of claim 31, the processing device further operative to:
associate a plurality of credit providers with the buyer extending lines of credit to the buyer; and
generate a credit profile for the buyer based on the lines of credit from the plurality of credit providers.

35. The electronic trade servicing device of claim 34 wherein the pledging the at least a portion of the line of credit includes pledging varying amount of credit from different credit providers.

36. The electronic trade service device of claim 34 wherein the pledging the at least a portion of the line of credit includes pledging amount of credit proportional to the credit providers share of the buyer's credit profile.

37. The electronic trade service device of claim 31, the processing device further operative to:
provide a notification to the credit provider once the portion of the line of credit has been pledged in the agreement.

38. The electronic trade service device of claim 37 wherein the notification is transmitted using an electronic mail communication.

39. The electronic trade service device of claim 31, the processing device is further operative to:
generate a credit profile for the seller based on the pledged portion of the line of credit; and
make the credit status of the buyer available for inspection by a plurality of credit providers.

40. The electronic trade service device of claim 39 wherein the credit status is usable by one or more credit providers prior to extending a line of credit.

41. The electronic trade service device of claim 39 wherein the credit status is usable by the seller prior to entering into the agreement.

42. The electronic trade service device of claim 31, the processing device is further operative to:
transfer a discounted payment to the seller from the buyer prior to an agreed upon payment date, wherein the discounted payment satisfies the payment obligations under the agreement and the discount payment represents an adjustment in the price term reflective of a time period between payment of the discounted payment and the payment date.

43. The electronic trade service device of claim 31, the processing device is further operative to:
define repayment terms between the seller and the credit provider for any outstanding balances due associated with the line of credit, the repayment terms include installment payments dates and an interest rate; and
facilitate installments payments between the seller and the credit provider.

44. The electronic trade service device of claim 31 wherein the line of credit is pledged to the seller for payment at a time relating to a particular step in at least one of:
development and delivery, of the contractual goods such that a seller verifies completion of a defined task at the particular step and at least one of: the credit provider and buyer authorizes payment to the seller.

45. The electronic trade service device of claim 31 further comprising:
generate a contract between the seller and a supplier based on the contractual terms of the agreement;
define supplier contract terms including a supplier price term and a supplier payment date;
finalize the supplier contract without using a line of credit; and
facilitate payment of a discount supplier price term at a date prior to the supplier payment date, wherein the discounted supplier payment satisfies payment obligations under the supplier agreement and the discount payment represents an adjustment in the price term reflective of a time period between payment of the discounted payment and the supplier payment date.
